(19) United States
(12) Patent Application Publication
(10) Pub. No.: US 2008/0062001 A1
(43) Pub. Date: Mar. 13, 2008

(54) MOTION CONTROL APPARATUS AND METHOD THEREOF

(75) Inventors: Chih-Feng Hsu, Taoyuan City (TW); Yih-Feng Kao, Taoyuan City (TW); Kuo-Chen Wu, Taoyuan City (TW); Ming-San Huang, Taoyuan City (TW); John C. Wang, Taoyuan City (TW)

Correspondence Address: OCCHIUTI ROHLICEK & TSAO, LLP, 10 FAWCETT STREET, CAMBRIDGE, MA, 02138, US

(73) Assignee: High Tech Computer Corp., Taoyuan City (TW)

(21) Appl. No.: 11/850,865

(22) Filed: Sep. 6, 2007

(30) Foreign Application Priority Data
Sep. 8, 2006 (TW) 95133347

(51) Int. Cl. G08B 21/00; G09G 5/00

(52) U.S. Cl. 340/689; 345/156

(57) ABSTRACT

A control apparatus to control a page displayed in an electronic device is disclosed. The apparatus includes a motion sensor for detecting the motion of the electronic device to send a plurality of motion parameter of detected points, a processor for receiving the motion parameter to determine tilting angles and a tilting speeds of the electronic device based on the motion parameters and to determine an average tilting speeds by averaging the previous predetermined number tilting speeds, wherein the average tilting speeds are compared with a predetermined speed to determine a content-movement speed.

### RELATED APPLICATIONS

This application claims priority to Taiwan Application Serial Number 95133347, filed Sep. 8, 2006, which is herein incorporated by reference.

### FIELD OF THE INVENTION

The present invention relates to a method and apparatus for controlling a display, and more particularly to a method and apparatus for controlling a display by device's tilting.

### BACKGROUND OF THE INVENTION

Mobile electronic devices such as PDAs, tablet PCs, and laptop computers are becoming increasingly popular with consumers, but navigation using input devices such as touch pads, styluses, trackballs, and/or track points often proves to be both troublesome and time consuming for many users. Performing simple navigational tasks with these mechanisms can require numerous hand movements and repetitive gestures.

Gesture-based interaction, on the other hand, provides users with a more natural and convenient alternative to traditional input mechanisms. Users can control a cursor and/or scrolling movements by simply tilting the device. While tilting is convenient for wide-range cursor pointing or scrolling within long content lists, precise navigation remains somewhat problematic for many users.

Most existing algorithms within gesture-driven input devices have a tilting-motion-to-content-movement ratio that is predetermined. One degree of tilting will move the cursor or scrollbar by a fixed number of pixels. If the tilting angle is increased, the cursor/scrollbar moves proportionally but still only by the predetermined number of pixels for each degree of tilting. Since screens usually contain a large number of pixels, the predetermined tilting-motion-to-content-movement ratio is high in most devices. Even tilting the device slightly will move the cursor/scrollbar noticeably. This makes precise navigation within small areas of the screen incredibly difficult.

Therefore, a new control apparatus and control method is required.

### SUMMARY OF THE INVENTION

The main purpose of the present invention is to provide a display control apparatus and method thereof to adjust the content movement velocity in the display by calculating the tilting speed of the electronic device.

Accordingly, a control apparatus to control a page displayed in an electronic device is disclosed. The apparatus includes a motion sensor, for detecting the motion of the electronic device to send a plurality of motion parameter of detected points, a processor, for receiving the motion parameter to determine an average tilting speed by averaging the previous predetermined number tilting speeds, wherein the average tilting speeds are compared with a predetermined speed to determine a content-movement speed, and a controller, to move the page based on the content-movement speed.

According to another embodiment, a control method to control a page displayed by an electronic device is disclosed. The method comprises to detect the motion of the electronic device in respect to a special position to send a plurality of motion parameter of detected points sequentially, to receive the motion parameter to determine tilting angles and tilting speeds of the electronic device based on the motion parameters, to determine an average tilting speeds by averaging the previous predetermined number of tilting speeds, to compare the average tilting speeds with a predetermined speed to determine a content-movement speed, and to move the page based on the content-movement speed.

According to the present invention, the speed and direction of the content-movement is related to the speed and direction of tilting electrical device. Therefore, the searching method is easy for a user

### BRIEF DESCRIPTION OF THE DRAWINGS

The foregoing aspects and many of the attendant advantages of this invention will become more readily appreciated and better understood by referencing the following detailed description, when taken in conjunction with the accompanying drawings, wherein:

FIG. 1 illustrates a schematic diagram of a display controller according to a preferred embodiment.

FIG. 2 illustrates a relationship diagram of the tilting angle and the average tilting speed according to an embodiment of the present invention.

FIG. 3 illustrates a schematic diagram of an electronic device with the display control apparatus of the present invention.

FIG. 4 illustrates a relationship diagram of the tilting angle and the average tilting speed according to an another embodiment of the present invention.

FIG. 5 illustrates a flow chart for controlling the display according to an embodiment of the present invention.

### DETAILED DESCRIPTION OF THE PREFERRED EMBODIMENT

According to the present invention, during the tilting process, an algorithm records the G-sensor's tilting angle acceleration values and determines whether users want expansive or precise browsing by calculating the tilting average speed. If the tilting average speed is below a predetermined speed number, the content-movement speed in the display is set low for precise browsing. Conversely, if the tilting average speed passes the predetermined number, content-movement speed in the display is set higher for expansive browsing.

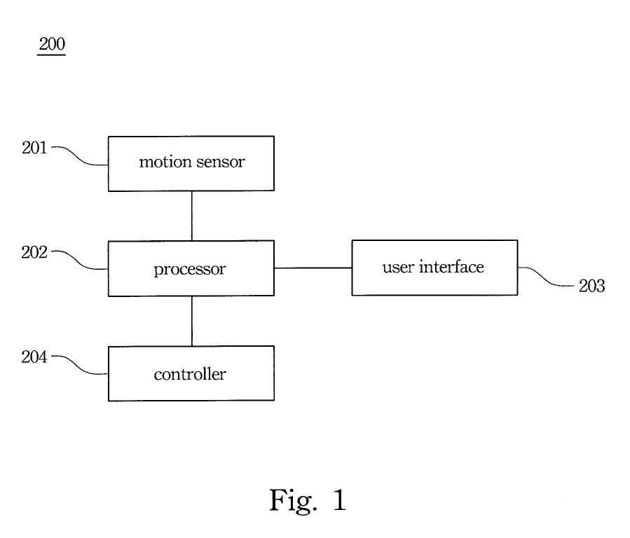

FIG. 1 illustrates a schematic diagram of a display controller according to a preferred embodiment. The display control apparatus 200 is embedded in a portable electronic device, such as a mobile phone, a personal digital assistant (PDA), a notebook and so on.

The display control apparatus 200 of the present invention includes a motion sensor 201, a processor 202 and a controller 204 for controlling a content-movement velocity. The motion sensor 201 is, for example, a 2-axle accelerator, a 3-axle accelerator, an inclinometer or a compass sensor. The motion sensor 201 senses the motion of the electronic device and sends out a corresponding motion parameter, such as the tilting angle acceleration values.

The processor 202 couples with the motion sensor 201 to receive the motion parameter and calculates the tilting speed of the electronic device based on the motion parameter. The tilting speed is related to the velocity and direction of the content-movement and the relationship thereof may be pre-programmed in the processor 202 or pre-defined by the user through the user interface 203. After the processor 202 receives a motion parameter sent out from the motion sensor 201, a corresponding display instruction is triggered. This display instruction is sent to the controller 204 to move the content displayed in the electronic device based on motion direction and motion velocity defined by the processor.

In an embodiment, the motion sensor 201 is a 2-axle accelerator for detecting the motion parameter of the electrical device. When a user tilts an electronic device, the motion sensor 201 embedded in the electronic device detects tilting angle acceleration values and then a corresponding motion parameter is generated and sent to the processor 202. After the motion parameter is sent to the processor 202, the motion parameter is transformed to a tilting angle of the electronicel device relative to the X-axis (or the Y-axis) by the processor 202. Based on the angle, a corresponding instruction is sent to the controller 204 from the processor 202 to move the content displayed in the electronic device using a special velocity and along a special direction.

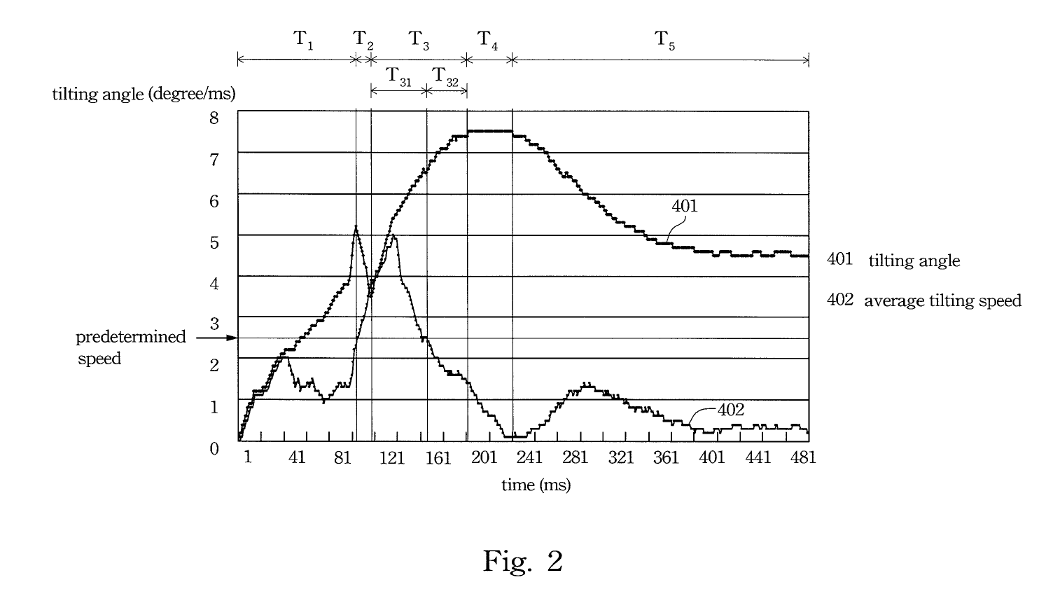

FIG. 2 illustrates a relationship diagram of the tilting angle and the average tilting speed according to an embodiment of the present invention. The transverse axle represents the time of detecting the electrical device. In this embodiment, the electronic device is detected by the motion sensor 201 once every 1 ms. The vertical axle is the motion parameter. In this embodiment, the motion parameter is the tilting angle. Each point in the curve 401 represents the tilting angle of the electrical device. An absolute value of the difference of the tilting angle between two adjacent detected points is defined as the tilting speed of the electrical device. In this embodiment, to prevent the content-movement speed from repeatedly changing, an average tilting speed curve 402 determines whether or not the content-movement speed has to be changed. The average tilting speed in the curve 402 is determined by calculating the tilting speed from the previous 40 tilting speed.

In an embodiment, the processor 202 instructs the controller 204 to move the content in a first content-movement speed when the average tilting speed is less than a predetermined speed. On the other hand, the processor 202 instructs the controller 204 to move the content in a second content-movement speed when the average tilting speed is larger than a predetermined speed. The predetermined speed and the denominator number for calculating the average tilting speed are set by the user through the interface 203. In another embodiment, many predetermined speeds can be set to define many content-movement speeds. According to this embodiment, the content-movement speeds can be set equal to the predetermined speeds respectively. For example, three predetermined speeds, a first predetermined speed, a second predetermined speed and a third predetermined speed, are set to define four content-movement speeds. The content-movement speed is set equal to the second predetermined speed if the average tilting speed is located between the first predetermined speed and the second predetermined speed. Moreover, in another embodiment, the content-movement speed is set proportional to the tilting speed of the electrical device.

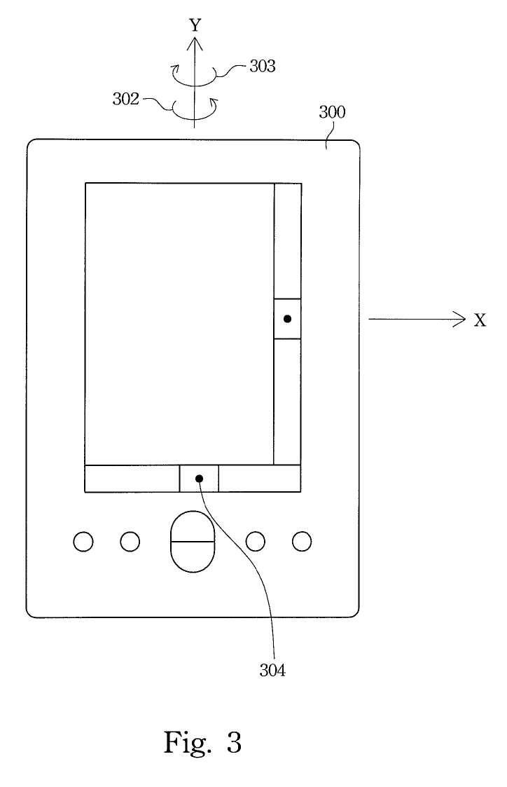

FIG. 3 illustrates a schematic diagram of an electronic device with the display control apparatus of the present invention. According to the embodiment, the initial location of the electronic device 300 is parallel to the page. When the electronic device 300 is rotated anticlockwise around the Y-axis, indicated by the arrow 302, the thumb (the wiper of scrollbar) 304 moves toward the positive X-axis to display the right-side of the page. On the other hand, when the electronic device 300 is rotated clockwise around the Y-axis, indicated by the arrow 303, the thumb (the wiper of scrollbar) 304 moves toward the negative X-axis to display the left-side of the page. Moreover, the user also defines that the predetermined speed is 2.5 (degree/ms). When the average tilting speed is less than the predetermined speed, the content-movement speed is the slower first content-movement speed. When the average tilting speed is larger than the predetermined speed, the content-movement speed is the faster second content-movement speed. When the average tilting speed is zero, the content-movement speed is zero too.

The following is an example of the application of the preset invention. It is noticed that only the situation of the electronic device 300 rotated around the Y-axis is described in this example. However, the situation of the electronic device 300 rotating around the X-axis may be deduced by analogy.

Please refer to the FIG. 2 and FIG. 3 together. When the electronic device 300 is rotated anticlockwise around the Y-axis, indicated by the arrow 302, the included angle between the electronic device 300 and the X-axis is increased. In the time segment T1, the average tilting speed is always less than 2.5 (degree/ms). Therefore, the thumb 304 is the first content-movement speed and moves toward the positive X-axis to display the right-side of the page.

In the time segment T2, the electronic device 300 is rotated clockwise around the Y-axis, indicated by the arrow 303, the included angle between the electronic device 300 and the X-axis is decreased. In this time segment, the average tilting speed is always larger than 2.5 (degree/ms). Therefore, the thumb 304 is the second content-movement speed and moves toward the negative X-axis to display the left-side of the page.

In the time segment T3, the electronic device 300 is rotated anticlockwise around the Y-axis again, indicated by the arrow 302, the included angle between the electronic device 300 and the X-axis is increased. However, the included angle change in each unit time is slowed down. Therefore, the average tilting speed is also slowed down. Accordingly, in time segment T31, the average tilting speed is still larger than 2.5 (degree/ms). Therefore, the thumb 304 is the second content-movement speed and moves toward the positive X-axis to display the right-side of the page. On the other hand, in time segment T32, the average tilting speed has been less than 2.5 (degree/ms). Therefore, the thumb 304 is the first content-movement speed and moves toward the positive X-axis to display the right-side of the page.

In time segment T4, the electronic device 300 stops rotating. Therefore, the included angle between the electronic device 300 and the X-axis does not change. Therefore, the average tilting speed is slowed down again. Accordingly, the average tilting is still less than 2.5 (degree/ms). The thumb 304 is the first content-movement speed and moves toward the positive X-axis to display the right-side of the page.

In time segment T5, the electronic device 300 is rotated clockwise around the Y-axis, indicated by the arrow 303. The included angle between the electronic device 300 and the X-axis is decreased. In this time segment, the average tilting speed is always less than 2.5 (degree/ms). Therefore, the thumb 304 is the first content-movement speed and moves toward the negative X-axis to display the left-side of the page.

In other words, according to this embodiment, a user may vary the speed and direction of tilting electronic device to change the speed and direction of the content-movement. For example, when a user wants to search a special content in a page, at the beginning of the search, the user may follow a predetermined direction to tilt the electronic device in a higher speed to make this page have a higher content-movement speed to reach the special content. When the special content has been reached, the user may slow down the tilting speed and tilt the electronic device clockwise or anticlockwise to carefully adjust the display content to fit comfortable viewing. Accordingly, the speed and direction of the content-movement is related to the speed and direction of tilting electrical device. Therefore, the searching method is easy for a user.

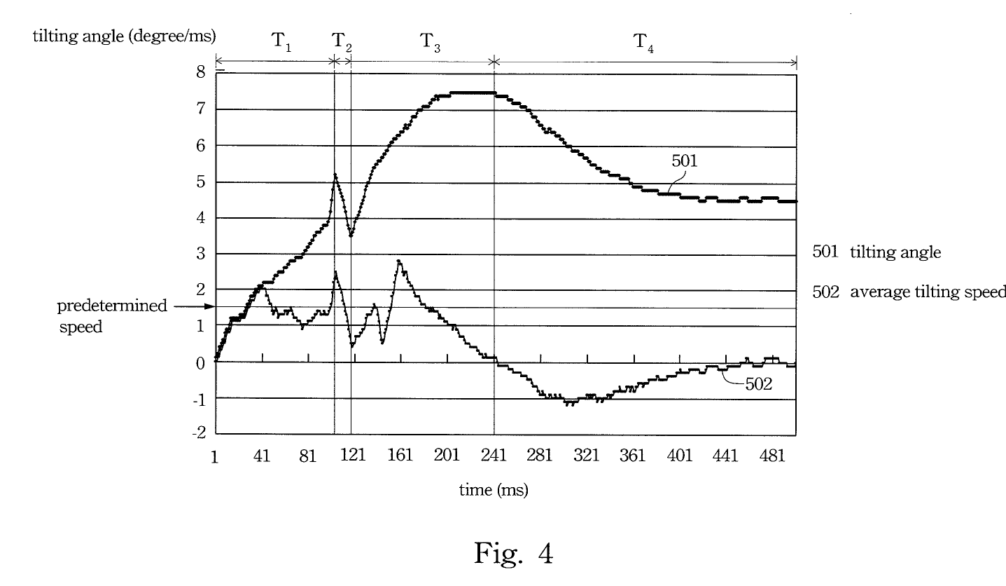

FIG. 4 illustrates a relationship diagram of the tilting angle and the average tilting speed according to an another embodiment of the present invention. The transverse axle represents the time of detecting the electrical device. In this embodiment, the electronic device is detected by the motion sensor 201 once every 1 ms. The vertical axle is the motion parameter. In this embodiment, the motion parameter is the tilting angle. Each point in the curve 501 represents the tilting angle of the electrical device. A difference of the tilting angle between two adjacent detected points is defined as the tilting speed of the electrical device. In this embodiment, the tilting speed does not an absolute value of the difference. In other words, when the difference of the tilting angle between two adjacent detected points is a negative value. The tilting speed is a negative value in this embodiment. Therefore, a negative tilting speed is represented in the curve 502. In this embodiment, the content-movement direction is determined by the positive value and negative value of the average tilting speed. Moreover, the processor 202 instructs the controller 204 to move the content in a first content-movement speed when the average tilting speed is less than a predetermined speed, such as 1.5 degree/ms. The processor 202 instructs the controller 204 to move the content in a second content-movement speed when the average tilting speed is larger than the predetermined speed. Moreover, the content-movement speed is zero when the average tilting speed is zero. In another embodiment, many predetermined speeds can be set to define many content-movement speeds.

In this embodiment, the content-movement direction is determined by the positive value and negative value of the average tilting speed. Accordingly, when the average tilting speed is a positive value as shown in the time segments T1 to T3, the thumb 304 as shown in the FIG. 3 moves toward the positive X-axis to display the right-side of the page. When the average tilting speed is a negative value as shown in the time segment T4, the thumb 304 as shown in the FIG. 3 moves toward the negative X-axis to display the left-side of the page. In other words, the different rotation directions of the electronic device do not change the content-movement direction in real time, but may slow down the content-movement speed.

For example, when the electronic device 300 is rotated anticlockwise around the Y-axis, indicated by the arrow 302, and the average tilting speed is larger than the predetermined speed, the thumb 304 is the second content-movement speed and moves toward the positive X-axis to display the right-side of the page. On the other hand, when the electronic device 300 is rotated clockwise around the Y-axis, indicated by the arrow 303, the included angle between the electronic device and X-axle is reduced. Therefore, the tilting speed is a negative value to reduce the average tilting speed. When the average tilting speed is less than the predetermined speed, the thumb 304 is the first content-movement speed and moves toward the positive X-axis to display the right-side of the page. When the average tilting speed is zero, the content-movement speed is zero too. At this time, if the user rotates the electronic device 300 clockwise around the Y-axis again, indicated by the arrow 303, the thumb 304 moves toward the negative X-axis to display the left-side of the page. Therefore, in this embodiment, even though the user changes the direction of the tilting electronic device in a moment, the content-movement direction is not changed in a moment. The moment change of the direction of tilting electronic device only may slow down the content-movement speed.

Accordingly, in the time segment T1, the electronic device 300 is rotated anticlockwise around the Y-axis, indicated by the arrow 302, the included angle between the electronic device 300 and the X-axis is increased. In this time segment of the average tilting speed less than 1.5 (degree/ms), the thumb 304 is the first content-movement speed and moves toward the positive X-axis to display the right-side of the page. In this time segment of the average tilting speed larger than 1.5 (degree/ms), the thumb 304 is the second content-movement speed and moves toward the positive X-axis to display the right-side of the page.

In the time segment T2, the electronic device 300 is rotated clockwise around the Y-axis, indicated by the arrow 303, the included angle between the electronic device 300 and the X-axis is decreased. In this time segment T2, the tilting electronic device direction is changed. Therefore, the average tilting speed is reduced. When the average tilting speed is reduced to less than 1.5 (degree/ms), the speed of thumb 304 is reduced from the second content-movement speed to the first content-movement speed. However, the thumb 304 still moves toward the positive X-axis to display the right-side of the page.

In the time segment T3, the electronic device 300 is rotated anticlockwise around the Y-axis, indicated by the arrow 302. The included angle between the electronic device 300 and the X-axis is increased. However, the change of the included angle in a unit time is slowed down to reduce the average tilting speed. In this time segment of the average tilting speed less than 1.5 (degree/ms), the thumb 304 is the first content-movement speed and moves toward the positive X-axis to display the right-side of the page. In this time segment of the average tilting speed larger than 1.5 (degree/ms), the thumb 304 is the second content-movement speed and moves toward the positive X-axis to display the right-side of the page. In the end of the time segment T3, the average tilting speed is zero, therefore, the content-movement speed is also zero.

In the time segment T4, the electronic device 300 is rotated clockwise around the Y-axis, indicated by the arrow 303. The included angle between the electronic device 300 and the X-axis is decreased. In this time segment T4, the average tilting speed is less than zero and the absolute value of the average tilting speed is less than 1.5 (degree/ms). The thumb 304 moves toward the negative X-axis to display the left-side of the page.

In other words, according to this embodiment, a user may vary to tilt the electronic device speed and direction to change the content-movement speed and direction. For example, when a user wants to search a special content in a page, at the beginning of the search, the user may follow a predetermined direction to tilt the electronic device in a higher speed to make this page have a higher content-movement speed to reach the special content. When the special content has been reached, the user may tilt the electronic device in a reversed direction to reduce the content-movement speed to carefully adjust the display content for comfortable viewing.

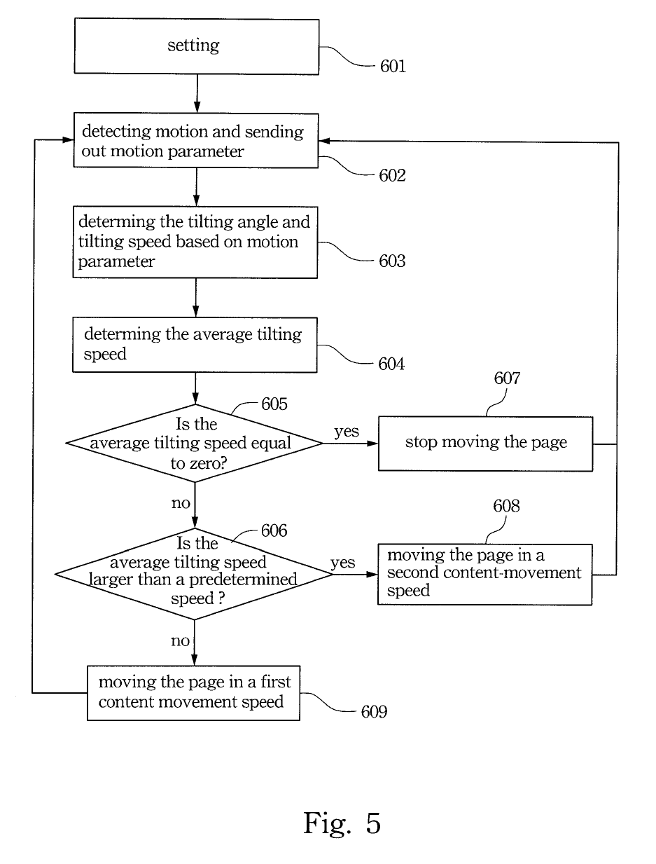

FIG. 5 illustrates a flow chart for controlling the display according to an embodiment of the present invention. In step 601, a user may set the control parameters through the user interface 203. For example, this user may set the first content-movement speed, the second content-movement speed and the predetermined speed. It is noticed that this step is a selective step. The above setting may be directly programmed in the processor 202. Next, in step 602, the motion sensor 201 senses the motion of the electronic device and sends out a motion parameter. In step 603, the processor 202 receives the motion parameters and transforms these parameters into angles to calculate the tilting speed of the electrical device. In step 604, an average tilting speed is calculated by averaging the previous predetermined number tilting speed. In step 605, a determination step is performed to determine whether or not the average tilting speed is zero. When the average tilting speed is zero, step 607 is performed to stop the content-movement. When the average tilting speed is not zero, step 606 is performed. In step 606, a determination step is performed to determine whether or not the average tilting speed is larger than a predetermined speed. When the average tilting speed is larger than a predetermined speed, step 608 is performed to move the content in the second content-movement speed. When the average tilting speed is less than a predetermined speed, step 609 is performed to move the content in the first content-movement speed.

In another embodiment, a predetermined speed for stop moving page can be set. When the average tilting speed is less than this predetermined speed, the content movement speed is zero. Many predetermined speeds can be set to define many content-movement speeds. Moreover, the content-movement speed is set to be proportional to the tilting speed of the electrical device.

As is understood by a person skilled in the art, the foregoing descriptions of the preferred embodiment of the present invention are an illustration of the present invention rather than a limitation thereof. Various modifications and similar arrangements are included within the spirit and scope of the appended claims. The scope of the claims should be accorded to the broadest interpretation so as to encompass all such modifications and similar structures. While a preferred embodiment of the invention has been illustrated and described, it will be appreciated that various changes can be made therein without departing from the spirit and scope of the invention.

What is claimed is:

1. A control apparatus installed in an electronic device to control a page displayed by the electronic device, the apparatus comprising:
a motion sensor for detecting the motion of the electronic device in respect to a special position to send at least one motion parameter of detected points sequentially;
a processor for receiving the motion parameter to determine a tilting angle and a tilting speed of the electronic device based on the motion parameter and to determine an average tilting speed by averaging the previous predetermined tilting speeds, wherein the average tilting speed is compared with a predetermined speed to determine a content-movement speed; and
a controller to move the page based on the content-movement speed.

2. The apparatus of claim 1, wherein the motion sensor is a 2-axle accelerator, a 3-axle accelerator, a compass sensor or an inclinometer.

3. The apparatus of claim 1, wherein the motion sensor detects the motion of the electronic device once every 1 ms.

4. The apparatus of claim 1, further comprising a stop moving page predetermined speed, wherein when the average tilting speed is less than the stop moving page predetermined speed, the page stops moving.

5. The apparatus of claim 1, wherein when the average tilting speed is larger than the predetermined speed, the page is moved in a second content-movement speed, and when the average tilting speed is less than the predetermined speed, the page is moved in a first content-movement speed, wherein the second content-movement speed is larger than the first content-movement speed.

6. The apparatus of claim 1, wherein the tilting speed is an absolute of a difference between the tilting angles of two adjacent detected points.

7. The apparatus of claim 6, wherein when the difference is a positive value, the page is moved toward a first direction, and when the difference is a negative value, the page is moved toward a second direction.

8. The apparatus of claim 1, wherein the tilting speed is a difference between the tilting angles of two adjacent detected points.

9. The apparatus of claim 8, wherein, when the average titling speed is a positive value, the page is moved toward a first direction, and when the average titling speed is a negative value, the page is moved toward a second direction.

10. The apparatus of claim 1, further comprising a user interface to define the predetermined number and the predetermined speed.

11. A control method to control a page displayed by an electronic device, the method comprising:
detecting the motion of the electronic device in respect to a special position to send at least one motion parameter of detected points sequentially;
receiving the motion parameter to determine a tilting angle and a tilting speed of the electronic device based on the motion parameter;
determining an average tilting speed by averaging the previous predetermined tilting speeds;
comparing the average tilting speed with a predetermined speed to determine a content-movement speed; and
moving the page based on the content-movement speed.

12. The method of claim 11, wherein the motion sensor is a 2-axle accelerator, a 3-axle accelerator, a compass sensor or an inclinometer.

13. The method of claim 11, wherein detecting the motion of the electronic device is performed once every 1 ms.

14. The method of claim 11, further comprising to set a stop moving page predetermined speed, wherein when the average tilting speed is less than the stop moving page predetermined speed, the page stops moving.

15. The method of claim 11, wherein when the average tilting speed is larger than the predetermined speed, the page is moved in a second content-movement speed, and when the average tilting speed is less than the predetermined speed, the page is moved in a first content-movement speed, wherein the second content-movement speed is large than the first content-movement speed.

16. The method of claim 11, wherein further comprising to set another predetermined speeds to define a plurality of speed segment corresponding to a plurality of content-movement speed, wherein the content-movement speeds are equal to the corresponding predetermined speeds.

17. The method of claim 16, wherein the content-movement speeds are proportional to the average tilting speed.

18. The method of claim 11, wherein the tilting speed is an absolute of a difference between the tilting angles of two adjacent detected points.

19. The method of claim 18, wherein when the difference is a positive value, the page is moved toward a first direction, and when the difference is a negative value, the page is moved toward a second direction.

20. The method of claim 11, wherein the tilting speed is a difference between the tilting angles of two adjacent detected points.

21. The method of claim 20, wherein when the average tilting speed is a positive value, the page is moved toward a first direction, and when the average tilting speed is a negative value, the page is moved toward a second direction.

22. The method of claim 11, further comprising to define the predetermined number and the predetermined speed.
